(19) United States
(12) Patent Application Publication
(10) Pub. No.: US 2017/0164213 A1
(43) Pub. Date: Jun. 8, 2017

(54) TRANSMISSION METHOD AND APPARATUS IN MOBILE COMMUNICATION SYSTEM

(71) Applicant: Electronics and Telecommunications Research Institute, Daejeon (KR)

(72) Inventors: Kwang Jae LIM, Daejeon (KR); Yu Ro LEE, Daejeon (KR); Taegyun NOH, Daejeon (KR)

(21) Appl. No.: 15/139,105

(22) Filed: Apr. 26, 2016

(30) Foreign Application Priority Data
Dec. 4, 2015 (KR) 10-2015-0172565
Dec. 4, 2015 (KR) 10-2015-0172570

(51) Int. Cl. H04W 24/02; H04W 72/12; H04J 11/00; H04L 5/00; H04W 72/04

(52) U.S. Cl. CPC H04W 24/02; H04L 5/005; H04W 72/0413; H04J 11/00; H04W 72/0446; H04W 72/1226

(57) ABSTRACT

A transmitter in a mobile communication system configures a short transmission time interval (TTI) using some transmission symbols in a subframe including a plurality of transmission symbols, multiplexes and transmits a reference signal and some of transmission data in a first symbol of the transmission symbols having the short TTI, and transmits the remainder of the transmission data in the remaining symbols except the first symbol.

### CROSS-REFERENCE TO RELATED APPLICATION

This application claims priority to and the benefit of Korean Patent Application No. 10-2015-0172570 and 10-2015-0172565 filed in the Korean Intellectual Property Office on Dec. 4, 2015 and Dec. 4, 2015, the entire contents of which are incorporated herein by reference.

### BACKGROUND OF THE INVENTION

(a) Field of the Invention

The present invention relates to a transmission method and apparatus in a mobile communication system, and more particularly, to a transmission method and apparatus having a transmission time interval (TTI) shorter than an existing TTI having a length of 1 ms in order to reduce transmission latency in an uplink of a mobile communication system.

(b) Description of the Related Art

In a Long Term Evolution (LTE) system, which is an existing well known mobile communication system, a transmission time interval (TTI) of an uplink is a subframe having a length of 1 ms, and a data transmission and reception and a data processing in a physical layer and a media access control (MAC) layer are performed at a subframe unit of 1 ms.

Since the LTE system has the TTI of 1 ms, it is not suitable for services requiring very short transmission latency such as tactile internet, real-time remote control, and the like. A transmission method having a TTI shorter than an existing TTI having the length of 1 ms is required for the services requiring the very short transmission latency.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a transmission method and apparatus in a mobile communication system suitable for services requiring short transmission latency.

An exemplary embodiment of the present invention provides a transmission method of a transmitter in a mobile communication system. The transmission method includes setting a time length of some transmission symbols to a short transmission time interval (TTI) in a subframe including a plurality of transmission symbols; multiplexing and transmitting a reference signal and some of transmission data in a first symbol of the transmission symbols within the short TTI; and transmitting the remainder of the transmission data in the remaining symbols except the first symbol among the transmission symbols within the short TTI.

The multiplexing and transmitting of the reference signal and some of the transmission data may include dividing a plurality of subcarriers configuring one resource block into a plurality of interlaces configured of the subcarriers spaced apart from each other by a plurality of subcarrier intervals; and mapping the reference signal and some of the transmission data to the subcarriers corresponding to different interlaces.

The multiplexing and transmitting of the reference signal and some of the transmission data may further include spreading the reference signal using an orthogonal code before the mapping of the reference signal and some of the transmission data to the subcarriers corresponding to different interlaces. The multiplexing and transmitting of the reference signal and some of the transmission data may further include setting a short resource block set obtained by grouping a plurality of resource blocks in a frequency domain to a resource allocation basic unit for transmitting the reference signal and the transmission data.

The transmission method may further include transmitting the reference signal and the transmission data for a continuous short TTI as much as the number of TTI bundlings according to a TTI bundling instruction.

The transmitting of the reference signal and the transmission data for the continuous short TTI may include multiplexing and transmitting the same control information and the transmission data in the continuous short TTI.

The control information may include channel status information (CSI).

The multiplexing and transmitting of the control information may include preferentially mapping the control information to the remaining subcarriers except a subcarrier to which the reference signal is mapped in the first symbol.

The multiplexing and transmitting of the control information may include preferentially mapping the control information to a resource element on a time axis among the remaining resource elements except a resource element to which the reference signal is mapped in the resource block.

Another exemplary embodiment of the present invention provides a transmission method of a transmitter in a mobile communication system. The transmission method includes setting a time length of one subslot to a short transmission time interval (TTI) in a subframe including a plurality of subslots; transmitting a reference signal in two subslots using one transmission symbol shared between the two subslots corresponding to an odd-numbered subslot and an even-numbered subslot; and transmitting transmission data using the remaining transmission symbols except one transmission symbol in the two subslots.

The transmitting of the reference signal may include dividing a plurality of subcarriers corresponding to one transmission symbol into two interlaces configured of the subcarriers spaced apart from each other by a plurality of subcarrier intervals within one resource block; and mapping the reference signal to the subcarriers corresponding to different interlaces in the two subslots.

The transmitting of the reference signal may further include spreading the reference signal using an orthogonal code before the mapping of the reference signal to the subcarriers corresponding to different interlaces.

The transmission method may further include setting a short resource block set obtained by grouping a plurality of resource blocks in a frequency domain to a resource allocation basic unit for transmitting the reference signal and the transmission data.

The transmission method may further include transmitting the reference signal and the transmission data for a continuous subslot as much as the number of TTI bundlings according to a TTI bundling instruction.

The transmitting of the reference signal and the transmission data for the continuous subslot may include multiplexing and transmitting the same control information and the transmission data in the continuous subslot.

The control information may include channel status information (CSI).

One transmission symbol may correspond to a final symbol of any one of two continuous subslots and correspond to a first symbol of the other subslot.

Yet another embodiment of the present invention provides a transmitter in a mobile communication system. The transmitter includes a reference signal generator, a discrete fourier transform (DFT) spreader, and a subcarrier mapper. The reference signal generator may generate a reference signal. The DFT spreader may perform a DFT spread for transmission data.

The subcarrier mapper may map and transmit the reference signal and the DFT spread data to a plurality of resource elements within at least one resource block within a short TTI set to a length of some transmission symbols in a subframe including a plurality of transmission symbols. The subcarrier mapper may divide a plurality of subcarriers configuring each of the resource blocks into a plurality of interlaces configured of the subcarriers spaced apart from each other by a plurality of subcarrier intervals, map the reference signal and some of the transmission data to the subcarriers corresponding to difference interlaces in a first symbol of the short TTI, and map the remainder of the transmission data to the plurality of subcarriers in a second symbol of the short TTI.

The subcarrier mapper may divide a plurality of subcarriers configuring each of the resource blocks into two interlaces configured of the subcarriers spaced apart from each other by a plurality of subcarrier intervals, map the reference signal to the subcarriers corresponding to difference interlaces in one transmission symbol shared by two subslots corresponding to an odd-numbered subslot and an even-numbered subslot, and map the DFT spread data to a plurality of subcarriers of the remaining transmission symbols except one transmission symbol in the two subslots.

### BRIEF DESCRIPTION OF THE DRAWINGS

FIG. 1 is a diagram illustrating a transmission time interval (TTI) in an existing mobile communication system.

FIG. 2 is a diagram illustrating a Hybrid Automatic Repeat Request Round Trip Time (HARQ RTT) and one-way transmission latency in an existing LTE system.

FIG. 3 is a drawing illustrating an uplink subframe having a short TTI according to an exemplary embodiment of the present invention.

FIG. 4 is a drawing illustrating an example of a resource unit for a transmission in the short TTI illustrated in FIG. 3.

FIG. 5 is a drawing illustrating an example of an orthogonal code transmission method in a resource block structure illustrated in FIG. 4.

FIG. 6 is a diagram illustrating a HARQ RTT and one-way transmission latency in a physical layer at the time of transmitting in the short TTI illustrated in FIG. 3.

FIGS. 7 and 8 are drawings each illustrating a HARQ timing and procedure of a case of using a subslot bundling in the short TTI structure illustrated in FIG. 3.

FIGS. 9 and 10 are drawings each illustrating a resource deployment of a case in which uplink control information and data are multiplexed to be transmitted in the short TTI structure illustrated in FIG. 3.

FIG. 11 is a drawing illustrating an uplink subframe having a short TTI according to another exemplary embodiment of the present invention.

FIG. 12 is a drawing illustrating an example of a resource unit for a transmission in the short TTI illustrated in FIG. 11.

FIG. 13 is a drawing illustrating an example of an orthogonal code transmission method in a resource block structure illustrated in FIG. 12.

FIG. 14 is a diagram illustrating a HARQ RTT and one-way transmission latency in a physical layer at the time of transmitting in the short TTI illustrated in FIG. 11.

FIGS. 15 and 16 are drawings each illustrating a HARQ timing and procedure of a case of using a subslot bundling in the short TTI structure illustrated in FIG. 11.

FIGS. 17 and 18 are drawings each illustrating a resource deployment of a case in which uplink control information and data are multiplexed to be transmitted in the short TTI structure illustrated in FIG. 11.

FIG. 19 is a drawing illustrating a transmitter according to an exemplary embodiment of the present invention.

FIG. 20 is a drawing illustrating a receiver according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise” and variations such as “comprises” or “comprising”, will be understood to imply the inclusion of stated elements but not the exclusion of any other elements.

Throughout the specification, a terminal may represent a mobile terminal (MT), a mobile station (MS), an advanced mobile station (AMS), a high reliability mobile station (HR-MS), a subscriber station (SS), a portable subscriber station (PSS), an access terminal (AT), a user equipment (UE), or the like, and may include all or some of the functions of the MT, the MS, the AMS, the HR-MS, the SS, the PSS, the AT, the UE, or the like.

In addition, a base station (BS) may represent an advanced base station (ABS), a high reliability base station (HR-BS), a node B, an evolved node B (eNodeB), an access point (AP), a radio access station (RAS), a base transceiver station (BTS), a mobile multi-hop relay (MMR)-BS, a relay station (RS) serving as the base station, a relay node (RN) serving as the base station, an advanced relay station (ARS) serving as the base station, a high reliability relay station (HR-RS) serving as the base station, a small base station [a femto BS, a home node B (HNB), a home eNodeB (HeNB), a pico BS, a metro BS, a micro BS, or the like], or the like, and may include all or some of the functions of the ABS, the nodeB, the eNodeB, the AP, the RAS, the BTS, the MMR-BS, the RS, the RN, the ARS, the HR-RS, the small base station, or the like.

Hereinafter, a transmission method and apparatus in a mobile communication system according to exemplary embodiments of the present invention will be described in detail with reference to the accompanying drawings.

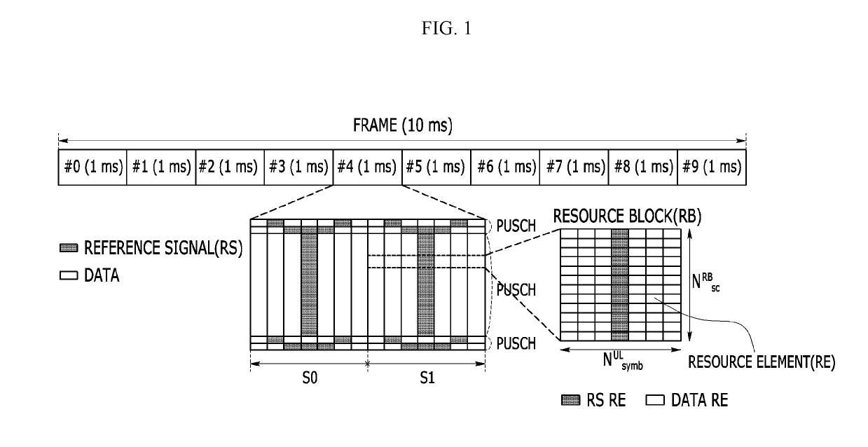

FIG. 1 is a diagram illustrating an uplink subframe in a mobile communication system.

Referring to FIG. 1, in a Long Term Evolution (LTE) system, which is a representative mobile communication system, one frame has a length of 10 ms in a time domain, and includes 10 subframes (#0 to #9) each of which a length is 1 ms.

A transmission time interval (TTI) in the LTE system is defined as a time for transmitting one subframe. That is, the TTI is used as a minimum time unit for transmitting data, and is set to be equal to a length of the subframe.

In the case of a frequency division duplex (FDD) frame in which a downlink and an uplink are divided by a frequency domain, a downlink subframe and an uplink subframe each include two slots S0 and S1, and each of the slots S0 and S1 has a length of 0.5 ms. In FIG. 1, only the uplink subframe is illustrated.

The slots S0 and S1 include a plurality of transmission symbols in a time domain, and include a plurality of subcarriers in a frequency domain. The transmission symbol may be called an orthogonal frequency division multiplex (OFDM) symbol, an orthogonal frequency division multiplex access (OFDMA) symbol, a single carrier-frequency division multiple access (SC-FDMA) symbol, and the like depending on a multiple access method. The number of transmission symbols included in one slot may be variously changed depending on a channel bandwidth or a length of a cyclic prefix (CP). For example, in the case of a normal CP, one slot includes 7 transmission symbols, but in the case of an extended CP, one slot includes 6 transmission symbols. FIG. 1 illustrates the subframe of the normal CP in which one slot includes 7 transmission symbols.

As illustrated in FIG. 1, the uplink subframe may be divided into a control region and a data region in the frequency domain. The control region is allocated with a physical uplink control channel (PUCCH) for transmitting uplink control information (UCI). The data region is allocated with a physical uplink shared channel (PUSCH) for transmitting uplink data.

A transport block (TB), which is a basic unit provided by an MAC layer for transmitting data in the uplink subframe, is transmitted through the PUSCH, which is a data channel, and a fourth symbol positioned at the center of each of the slots S0 and S1 in the PUSCH is used to transmit a reference signal (RS) for demodulating an uplink signal. A resource block (RB), which is a basic unit for transmitting data in the physical layer, is configured of N^{UL}_{symb} symbols and N^{RB}_{sc} subcarriers, and one RB may include N^{UL}_{symb}×N^{RB}_{sc} resource elements (RE).

The TB transferred from the MAC layer in the PUSCH of the existing LTE system is transmitted across one subframe. Therefore, the TTI, which is a basic unit of transmitting and receiving the TB, is 1 ms, which is the length of the subframe.

A downlink subframe is classified into a control region and a data region in the time domain. The control region may be allocated with a physical downlink control channel (PDCCH), a physical control format indicator channel (PCFICH), a physical hybrid automatic retransmit request Indicator channel (PHICH), or the like. The PHICH transmits a HARQ ACK (acknowledgement)/NACK (not-acknowledgement) signal as a response for the uplink transmission. The data region includes a physical downlink shared channel (PDSCH) for transmitting downlink data.

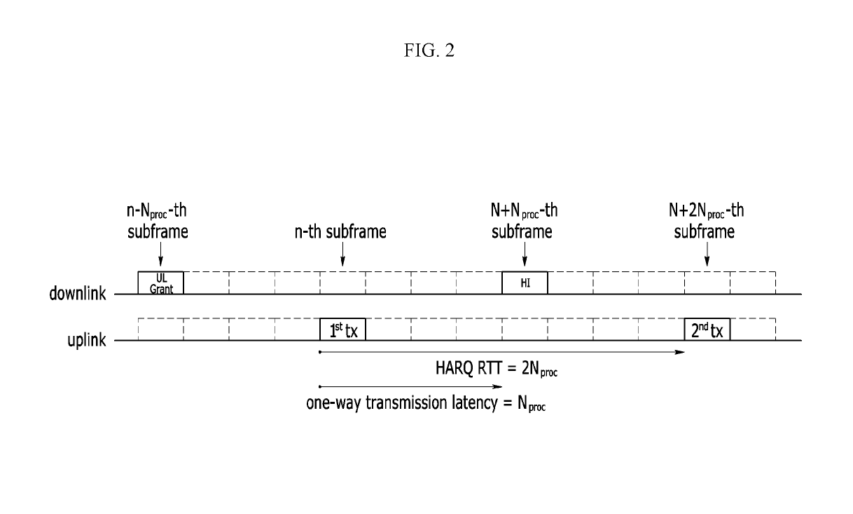

FIG. 2 is a diagram illustrating a Hybrid Automatic Repeat Request Round Trip Time (HARQ RTT) and one-way transmission latency in an existing LTE system.

Referring to FIG. 2, a resource for an uplink transmission is allocated by the PDCCH of the downlink including an uplink grant (UL) in a (n−N_{proc})-th subframe, and the uplink transmission (1^{st} tx) is performed in an n-th subframe. An HARQ response for the uplink transmission (1^{st} tx) is transferred through the PHICH of the downlink in a (n+N_{proc})-th subframe. In an LTE system of a FDD scheme, N_{proc}=4. In this case, when the HARQ response is the NACK, an uplink retransmission (2^{nd} tx) is performed in a (n+1N_{proc})-th subframe. Therefore, a hybrid automatic repeat request round trip time (HARQ RTT) in the physical layer is 2N_{proc} (=8 ms), and one-way transmission latency therein is N_{proc} (=4 ms).

As such, the TTI of 1 ms used for the existing LTE system is not suitable for a service requiring end-to-end transmission latency of 1 ms to 10 ms.

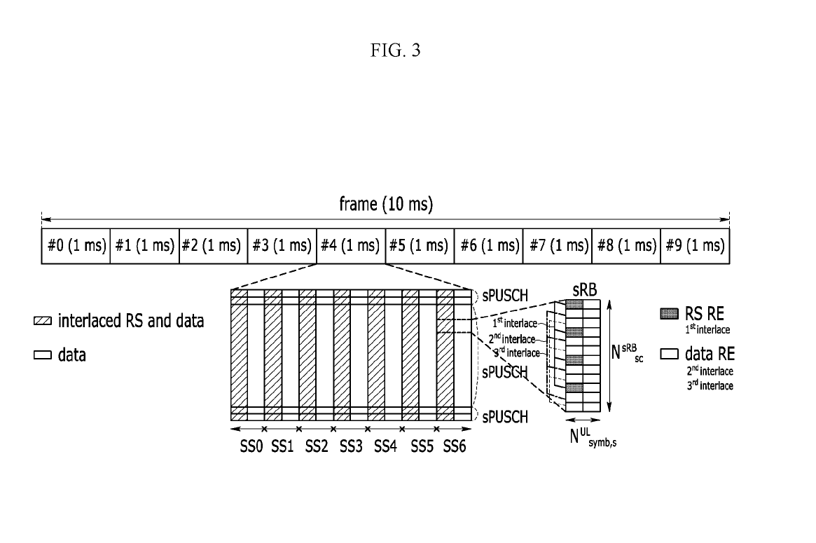

FIG. 3 is a drawing illustrating an uplink subframe having a short TTI according to an exemplary embodiment of the present invention.

Referring to FIG. 3, each of the uplink subframes includes a plurality of subslots. For example, each of the uplink subframes may be configured of 7 subslots (SS0 to SS6).

Each of the subslots (SS0 to SS6) has a time length corresponding to 1/7 of a length of the subframe. Each of the subslots (SS0 to SS6) includes two transmission symbols, wherein a first symbol of the two transmission symbols is used to transmit a reference signal (RS) and data, and a second symbol is used to transmit data. In this case, the number of transmission symbols configuring one subslot may be changed depending on the number of subslots configuring one uplink subframe. For example, when one subslot includes three transmission symbols, some of the three transmission symbols are used to transmit the reference signal (RS) and the data, and the remaining symbols are used to transmit the data. Hereinafter, it is described for convenience for explanation that one subslot includes two transmission symbols.

As such, in the uplink subframe configured of the subslots (SS0 to SS6), the TTI, which is a minimum time unit transmitting data, is set to a length of one subslot, and has a time length of about 1/7 as compared to the subframe, which is the TTI of the existing LTE system. In this case, hereinafter, in order to distinguish from the TTI of the existing LTE system, the TTI set to the length of one subslot is designated as a short TTI.

For a transmission in the short TTI, the subcarriers in a first symbol for transmitting the reference signal (RS) are divided into Nᵢₙₜₗ interlaces. The interlace means a subcarrier set including the subcarriers which are equally spaced. Each interlace is a set of the subcarriers which are spaced by an interval of Nᵢₙₜₗ subcarriers, and the subcarriers belonging to the interlace are not used to be overlapped with each other. A first interlace is used to transmit the reference signal, and from a second interlace to a Nᵢₙₜₗ-th interlace are used to transmit the data. In FIG. 3, it is illustrated that Nᵢₙₜₗ is 3.

The TB of the MAC layer is transmitted through a short PUSHC (sPUSCH), and a short resource block (sRB), which is a basic unit for transmitting the data in the sPUSCH, includes N^{UL}_{symb,s} symbols and N^{sRB}_{sc} subcarriers. The sPUSCH means the PUSCH allocated to the data region of the uplink subframe including the subslots (SS0 to SS6). The sRB includes N^{UL}_{symb,s}×N^{sRB}_{sc} REs. In an exemplary embodiment of the present invention, N^{UL}_{symb,s}=2. In a first symbol of each sRB, the reference signal and the data are transmitted through different interlaces.

Similar to the uplink subframe, the downlink subframe also includes the plurality of subslots, and one subslot is a short TTI in the downlink. The existing PDCCH, PDSCH, and PHICH of the downlink are operated in the short TTI unit, and are defined as sPDCCH, sPDSCH, and sPHICH in an exemplary embodiment of the present invention.

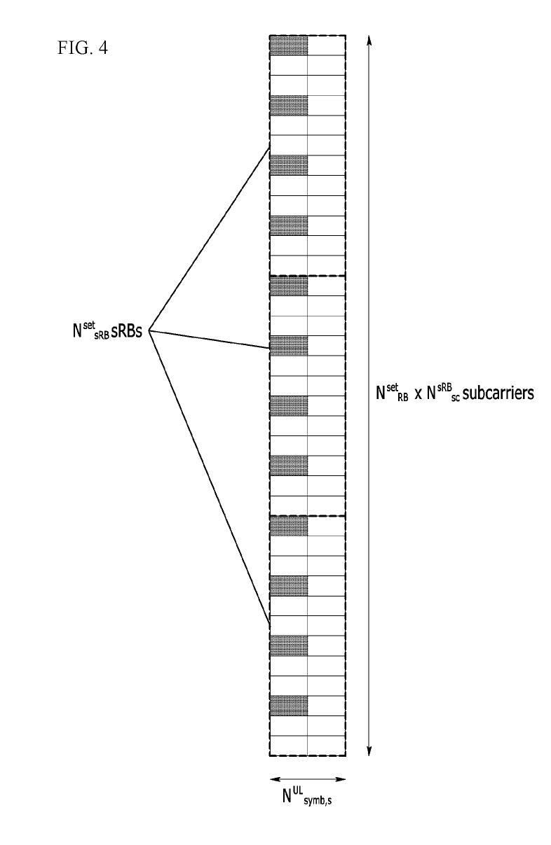

FIG. 4 is a drawing illustrating an example of a resource unit for a transmission in the short TTI illustrated in FIG. 3.

Referring to FIG. 4, the sRB has a symbol length which is reduced to about 1/7 as compared to the existing RB. Therefore, the number of data bits which may be transmitted in one sRB is reduced to about 1/7 as compared to the existing RB. Since this may cause a very short resource division in the time domain, N^{set}_{sRB} sRBs are grouped in the frequency domain to be defined as a short resource block set (sRBS), wherein the sRBS is used as a minimum resource unit in a resource allocation and a frequency hopping. In FIG. 4, it is illustrated that N^{set}s_{RB} is 3.

In addition, the number of REs (hereinafter, referred to as “RS RE”) for transmitting the reference signal (RS) in one sRB is reduced to N^{sRB}_{sc}/Nᵢₙₜₗ, but the number of RS REs in one sRBS becomes N^{set}_{sRB}×N^{sRB}_{sc}/Nᵢₙₜₗ. Therefore, a sequence length of the reference signal (RS) transmitted in one sRBS may be secured to be longer than that in one sRB.

For example, when N^{set}_{sRB}=Nᵢₙₜₗ and N^{RB}_{sc}=N^{sRB}_{sc}, the number of RS REs included in one sRBS is equal to a minimum sequence length N^{RB}_{sc} in the existing LTE system, and a sequence of the reference signal (RS) used in the existing LTE system may be used without being changed by allocating the resource using the sRBS as a basic unit.

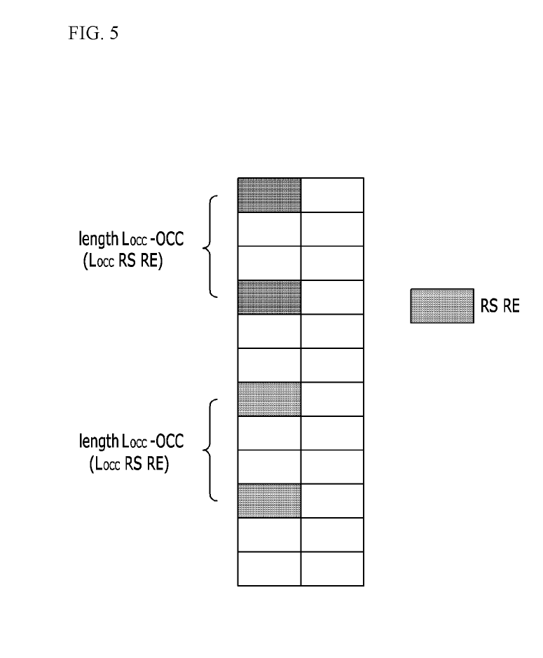

FIG. 5 is a drawing illustrating an example of an orthogonal code transmission method in a resource block structure illustrated in FIG. 4.

An orthogonal code is generally used to distinguish the reference signals transmitted by one or more users in the same resource.

In the existing LTE system, two symbols (hereinafter, referred to as “RS symbol”) for transmitting the reference signal (RS) on a time axis are transmitted to one uplink subframe, and an orthogonal code covering (OCC) having a length of 2 is used for two RS symbols.

As illustrated in FIG. 3, the subslots are used for the short TTI in the exemplary embodiment of the present invention, and one subslot or sRB includes only one transmission symbol for transmitting the reference signal (RS).

Therefore, as illustrated in FIG. 5, in the exemplary embodiment of the present invention, the orthogonal code having a length of L_{OCC} across L_{OCC} adjacent RS REs on a frequency axis is used for the OCC, not several transmission symbols for transmitting the reference signal (RS) on a time axis. In FIG. 5, it is illustrated that L_{OCC}=2.

When the OCC is used, the sequence of the reference signal (RS) uses the same value across the L_{OCC} adjacent RS REs. That is, each of element values configuring the sequence of the reference signal (RS) is repeated L_{OCC} times and transmitted.

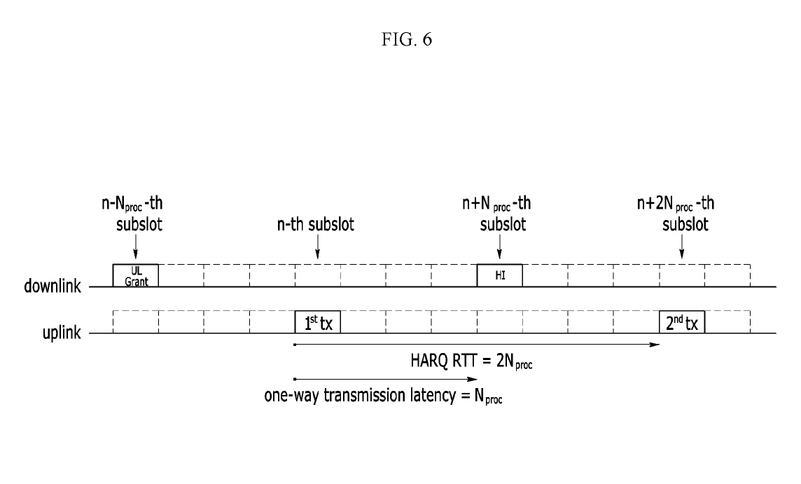

FIG. 6 is a diagram illustrating a HARQ RTT and one-way transmission latency in a physical layer at the time of transmitting in the short TTI illustrated in FIG. 3.

Also in a structure having the short TTI, the HARQ includes the uplink transmission for the resource allocation, the downlink HARQ response, and the uplink retransmission based on a processing time N_{proc}, similar to FIG. 2

However, the difference is that the time unit is the subframe in FIG. 2, but is the subslot, which is the short TTI, in FIG. 6.

Referring to FIG. 6, a resource for an uplink transmission is allocated by the sPDCCH including an uplink grant (UL) in a (n−N_{proc})-th subslot, and the uplink transmission (1^{st} tx) is performed in an n-th subslot through an allocated sPUSCH. An HARQ response for the uplink transmission (1^{st} tx) is transferred through the sPHICH of the downlink in a (n+N_{proc})-th subslot. In addition, when the HARQ response is the NACK, an uplink retransmission (2^{nd} tx) is performed in a (n+2N_{proc})-th subslot. In the short TTI structure, the N_{proc} is 1/7 ms. Therefore, the HARQ RTT in the physical layer is 8/7 (=2N_{proc})ms, and one-way transmission latency therein is 4/7 (=N_{proc})ms. Therefore, the short TTI according to an exemplary embodiment of the present invention may transmit packets of a service requiring the transmission latency of 1 ms to 10 ms.

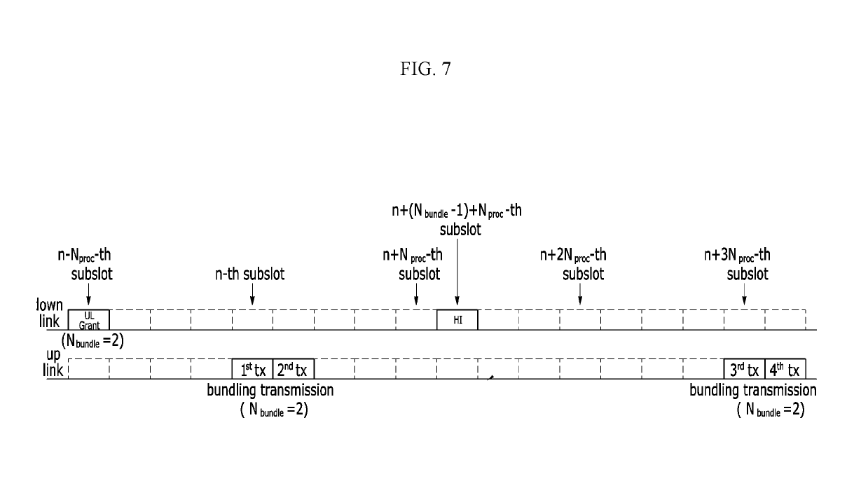

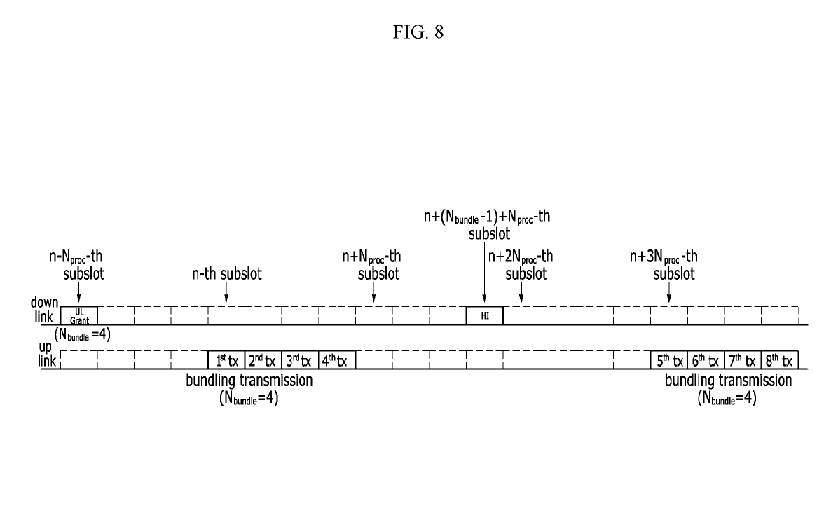

FIGS. 7 and 8 are drawings each illustrating a HARQ timing and procedure of a case of using a subslot bundling in the short TTI structure illustrated in FIG. 3.

Referring to FIGS. 7 and 8, the slot bundling means that the sPUSCH is transmitted in a plurality of continuous subslots (i.e., the short TTI) similar to the subframe bundling (or the TTI bundling) in the existing LTE system.

Unlike the downlink, a terminal has relatively limited transmission power as compared to a base station. Therefore, when the terminal transmits the sPUSCH at a cell boundary which is far away from the base station, the bundling is used to allow the base station to obtain more reception energy, and a sPUSCH coverage may be extended by the subslot bundling.

Whether or not the subslot bundling is performed is determined by a signaling message of an upper layer (RRC or MAC). The base station instructs the terminal to transmit the sPUSCH through the sPDCCH at the (n−N_{proc})-th subslot. The terminal transmits the sPUSCH across N_{bundle} continuous subslots at the n-th subslot.

The base station transmits the HARQ response through the sPHICH at a [n+(N_{bundle}−1)+N_{proc}]-th subslot, and in the case in which the HARQ response is the NACK, the base station retransmits the sPUSCH across the N_{bundle} continuous subslots at a (n+3N_{proc})-th subslot. In FIG. 7, the N_{bundle} is 2, and in FIG. 8, the N_{bundle} is 4.

The number (N_{bundle}) of subslots for the bundling transmission may be transmitted by the signaling message of the upper layer (RRC or MAC), and a suitable N_{bundle} for each of sPUSCH transmissions may be informed through a downlink control channel. In the case in which the N_{bundle} is informed through the downlink control channel, the transmission of the N_{bundle} may be controlled to be faster than the transmission by the signaling message of the upper layer for each of the packets depending on a latency requirement and a size of a service packet transmitted over the sPUSCH.

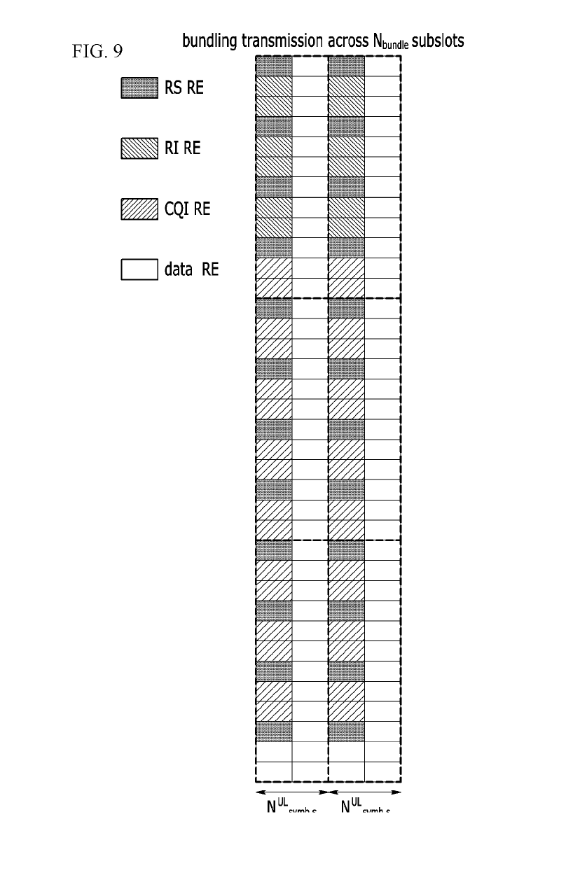

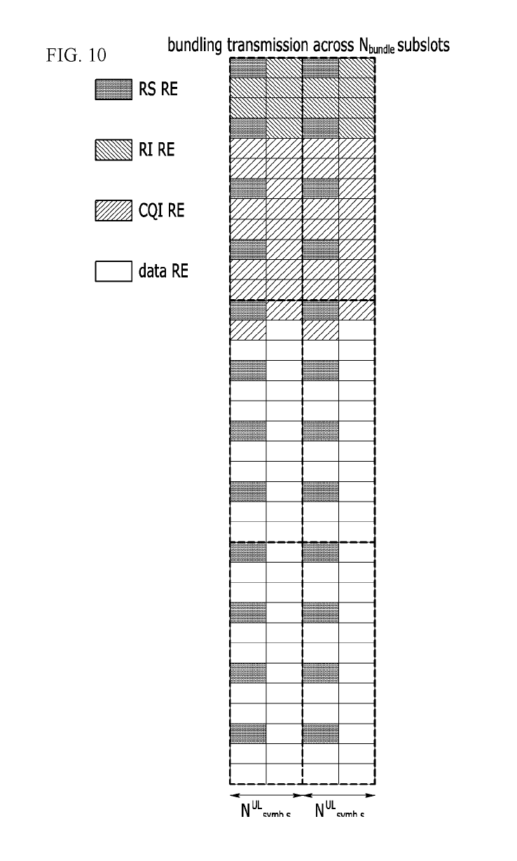

FIGS. 9 and 10 are drawings each illustrating a resource deployment of a case in which uplink control information and data are multiplexed to be transmitted in the short TTI structure illustrated in FIG. 3.

Similar to the existing LTE system, channel status information (CSI) may be transmitted over the sPUSCH, if necessary. The CSI includes a rank indicator (RI), a channel quality indicator (CQI), and a precoding matrix indicator (PMI).

In the existing LTE system, in the case in which aperiodic control information such as the CSI is multiplexed with the data and transmitted over the PUSCH and the subframe bundling is used, the control information is multiplexed and transmitted in only a corresponding subframe in which the control information should be transmitted. However, since the CSI does not require a very fast transmission latency of 1 ms, when the subslot bundling according to an exemplary embodiment of the present invention is used, the same control information may be transmitted across several subslots.

As illustrated in FIG. 9, in the sRB in which the control information and the data are multiplexed and allocated, the control information (RI, CQI) may be preferentially mapped to the RE (subcarrier) of the frequency axis except for the reference signal (RS).

Unlike this, as illustrated in FIG. 10, in the allocated sRB, the control information (RI, CQI) may also be preferentially mapped to the RE (transmission symbol) of the time axis except for the reference signal (RS).

Although FIGS. 9 and 10 illustrate a case in which the control information (RI, CQI) begins from a first subslot of the sPUSCH performing the bundling transmission, the transmission of the control information (RI, CQI) may be required from an intermediate or final subslot of the sPUSCH performing the bundling transmission. In this case, unlike FIGS. 9 and 10, the control information (RI, CQI) may be multiplexed and transmitted after the first subslot depending on a transmission timing of the control information (RI, CQI). In FIGS. 9 and 10, it is illustrated that N_{bundle}=2. Whether or not the control information (RI, CQI) is transmitted across several subslots which are bundled is informed by the signaling message (RRC or MAC) of the upper layer. When the uplink control information (RI, CQI) is transmitted across several subslots which are bundled, a coverage for a control information transmission may be extended similar to the case in which only the data is transmitted over the sPUSCH.

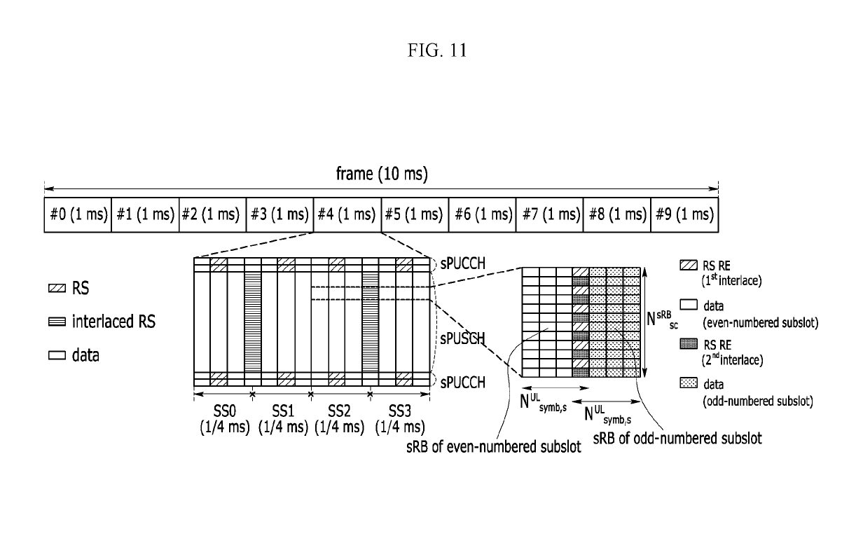

FIG. 11 is a drawing illustrating an uplink subframe having a short TTI according to another exemplary embodiment of the present invention.

Referring to FIG. 11, each of the uplink subframes may be configured of 4 subslots (SS0 to SS3). The short TTI is set to the length of one subslot as described above.

Each of the subslots (SS0 to SS3) has a time length corresponding to ¼ of a length of the subframe. Even-numbered subslots (SS0 and SS2) and odd-numbered subslots (SS1 and SS3) share and use one transmission symbol. For example, the subslot SS0 and the subslot SS1 share and use a fourth transmission symbol in the subframe, and the subslot SS2 and the subslot SS3 share and use an eleventh transmission symbol in the subframe. In this case, the fourth transmission symbol and the eleventh transmission symbol shared by the two subslots (SS0 and SS1/SS2 and SS3) are used to transmit the reference signal (RS). In addition, the remaining transmission symbols of each of the subslots (SS0 to SS3) are used to transmit the data.

As such, in the uplink subframe configured of four subslots (SS0 to SS3), the short TTI has a time length of about ¼ as compared to the TTI of the existing LTE system.

For the transmission in the short TTI, the subcarriers in the symbol for transmitting the reference signal (RS) are divided into two subcarrier sets, wherein a first subcarrier set is used to transmit the reference signal (RS) for the even-numbered subslots (SS0 and SS2), and a second subcarrier set is used to transmit the reference signal (RS) for the odd-numbered subslots (SS1 and SS3). The subcarriers belonging to the subcarrier sets used to transmit the reference signal (RS) are set to have two subcarrier intervals so as to have distributed single carrier-frequency division multiple access (SC-FDMA) signal characteristics.

The sRB includes N^{UL}_{symb,s} symbols and N^{sRB}_{sc} subcarriers, and in FIG. 11, N^{UL}_{symb,s}=4. The sPUSCH means the PUSCH allocated to the data region of the uplink subframe including the subslots (SS0 to SS3). The reference signal (RS) transmitted in a final transmission symbol of the sRB in the even-numbered subslots (SS0 and SS2) is transmitted in a first interlace (the odd-numbered subcarriers in FIG. 11), and the reference signal (RS) transmitted in a first transmission symbol of the sRB in the odd-numbered subslots (SS1 and SS3) is transmitted in a second interlace (the even-numbered subcarriers in FIG. 11).

Similar to the uplink subframe, the downlink subframe also includes the plurality of subslots, and one subslot is a short TTI in the downlink. The existing PDCCH, PDSCH, and PHICH of the downlink are operated in the short TTI unit, and are defined as the sPDCCH, sPDSCH, and sPHICH as described above.

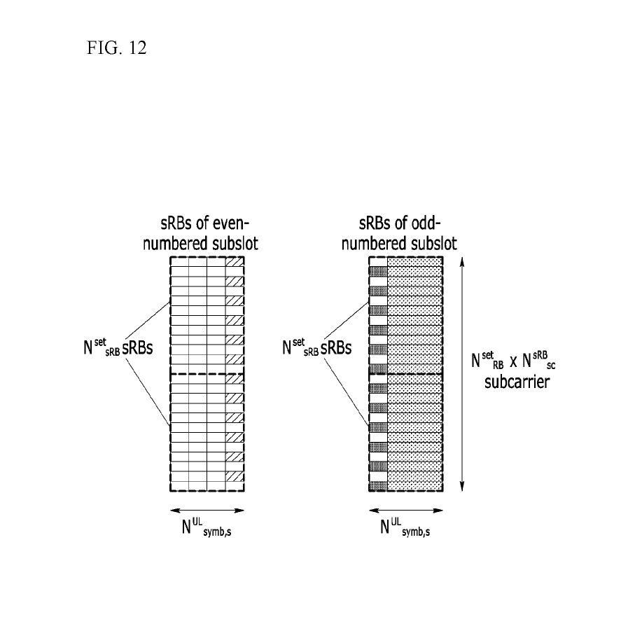

FIG. 12 is a drawing illustrating an example of a resource unit for a transmission in the short TTI illustrated in FIG. 11.

Referring to FIG. 12, the sRB has a symbol length which is reduced to about ¼ as compared to the existing RB. Therefore, the number of data bits which may be transmitted in one sRB is reduced to about ¼ as compared to the existing RB. Since this may cause a very short resource division in the time domain, N^{set}_{sRB} sRBs are grouped in the frequency domain to be defined as a short resource block set (sRBS), wherein the sRBS is used as a minimum resource unit in a resource allocation and a frequency hopping. In FIG. 12, it is illustrated that N^{set}s_{RB} is 2.

In addition, the number of REs (hereinafter, referred to as “RS RE”) for transmitting the reference signal (RS) in one sRB is reduced to N^{sRB}_{sc}/2, but the number of RS REs in one sRBS becomes N^{set}_{sRB}×N^{sRB}_{sc}/2. Therefore, a sequence length of the reference signal (RS) transmitted in one sRBS may be secured to be longer than that in one sRB.

For example, when N^{set}_{sRB}=2 and N^{RB}_{sc}=N^{sRB}_{sc}, the number of RS REs included in one sRBS is equal to a minimum sequence length N^{RB}_{sc} in the existing LTE system, and a sequence of the reference signal (RS) used in the existing LTE system may be used without being changed by allocating the resource using the sRBS as a basic unit.

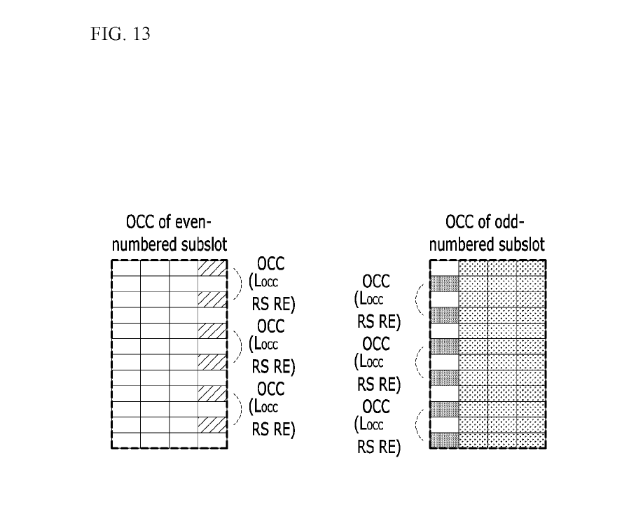

FIG. 13 is a drawing illustrating an example of an orthogonal code transmission method in a resource block structure illustrated in FIG. 12.

As illustrated in FIG. 11, the short TTI is set to a length of one subslot, and one subslot or the sRB includes only one transmission symbol to transmit the reference signal (RS). Particularly, even-numbered subslots and odd-numbered subslots share and use one transmission symbol.

Therefore, as illustrated in FIG. 13, an orthogonal code having a length of L_{OCC} is used across L_{OCC} adjacent RS REs on the frequency axis. In FIG. 13, it is illustrated that L_{OCC}=2.

When the OCC is used, the sequence of the reference signal (RS) uses the same value across the L_{OCC} adjacent RS REs. That is, each of element values configuring the sequence of the reference signal (RS) is repeated L_{OCC} times and transmitted.

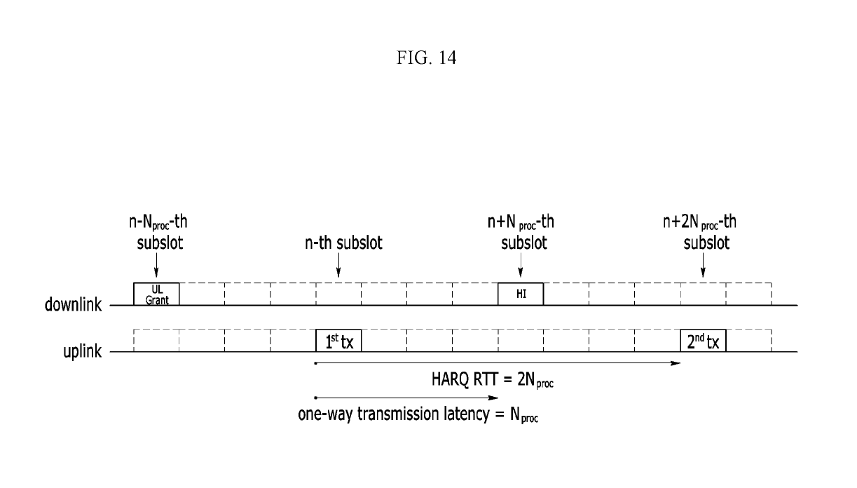

FIG. 14 is a diagram illustrating a HARQ RTT and one-way transmission latency in a physical layer at the time of transmitting in the short TTI illustrated in FIG. 11.

Referring to FIG. 14, a resource for an uplink transmission is allocated by the sPDCCH including an uplink grant (UL) in a (n−N_{proc})-th subslot, and the uplink transmission (1^{st} tx) is performed in an n-th subslot through an allocated sPUSCH. An HARQ response for the uplink transmission (1^{st} tx) is transferred through the sPHICH of the downlink in a (n+N_{proc})-th subslot. In addition, when the HARQ response is the NACK, an uplink retransmission (2^{nd} tx) is performed in a (n+2N_{proc})-th subslot. In the short TTI structure, the N_{proc} is 1 ms, which is ¼ of the N_{proc} in an existing TTI structure. Therefore, the HARQ RTT in the physical layer is 2 (=2N_{proc})ms, and one-way transmission latency therein is 1 (=N_{proc})ms. Therefore, the short TTI may transmit packets of a service requiring the transmission latency of 1 ms to 10 ms.

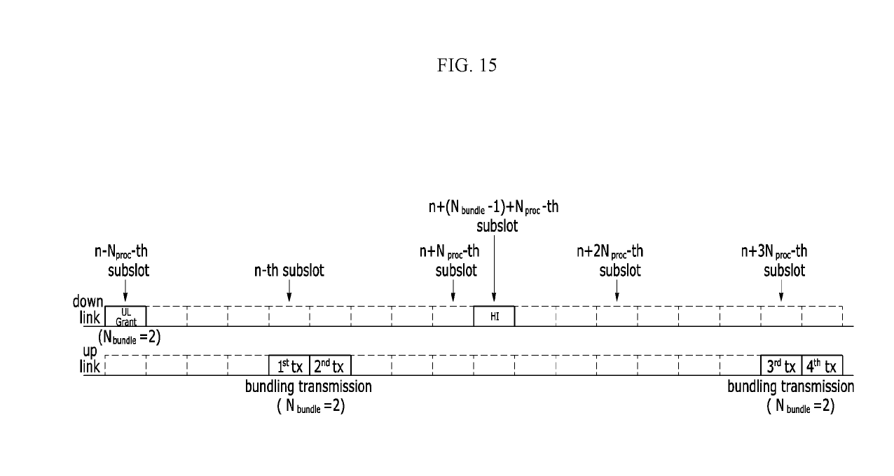

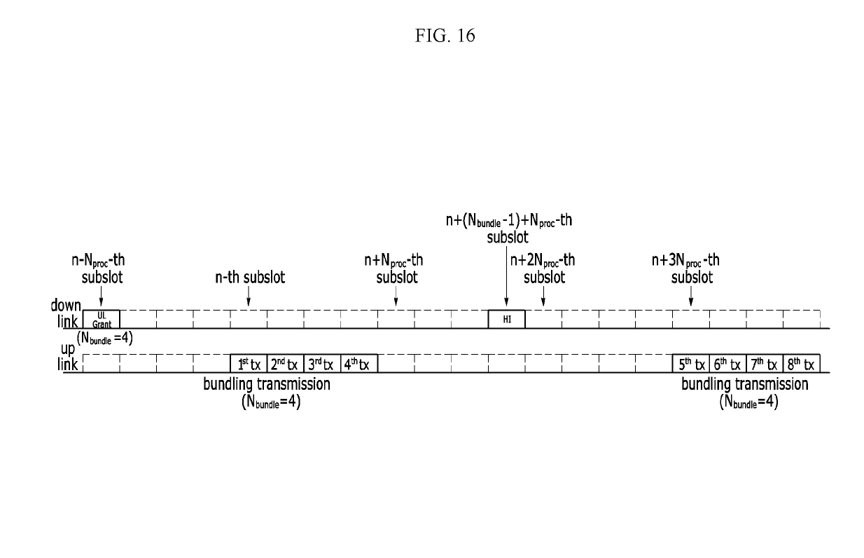

FIGS. 15 and 16 are drawings each illustrating a HARQ timing and procedure of a case of using a subslot bundling in the short TTI structure illustrated in FIG. 11.

Referring to FIGS. 15 and 16, the base station instructs the terminal to transmit the sPUSCH through the sPDCCH at the (n−N_{proc})-th subslot. The terminal transmits the sPUSCH across N_{bundle} continuous subslots at the n-th subslot.

The base station transmits the HARQ response through the sPHICH at a [n+(N_{bundle}−1)+N_{proc}]-th subslot, and in the case in which the HARQ response is the NACK, the base station retransmits the sPUSCH across the N_{bundle} continuous subslots at a (n+3N_{proc})-th subslot. In FIG. 15, the N_{bundle} is 2, and in FIG. 16, the N_{bundle} is 4.

As described above, the number (N_{bundle}) of subslots for the bundling transmission may be transmitted by the signaling message of the upper layer (RRC or MAC), and a suitable N_{bundle} for each of sPUSCH transmissions may be informed through a downlink control channel. In the case in which the N_{bundle} is informed through the downlink control channel, the transmission of the N_{bundle} may be controlled to be faster than the transmission by the signaling message of the upper layer for each of the packets depending on a latency requirement and a size of a service packet transmitted over the sPUSCH.

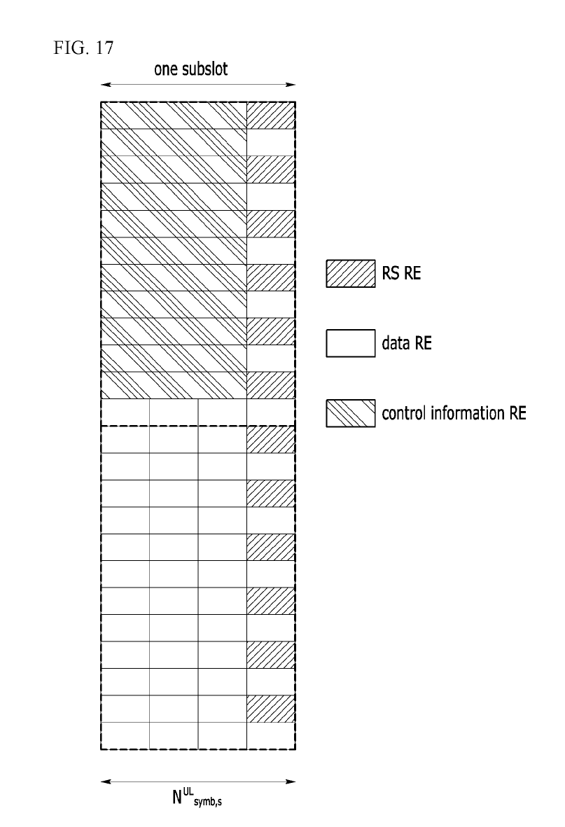

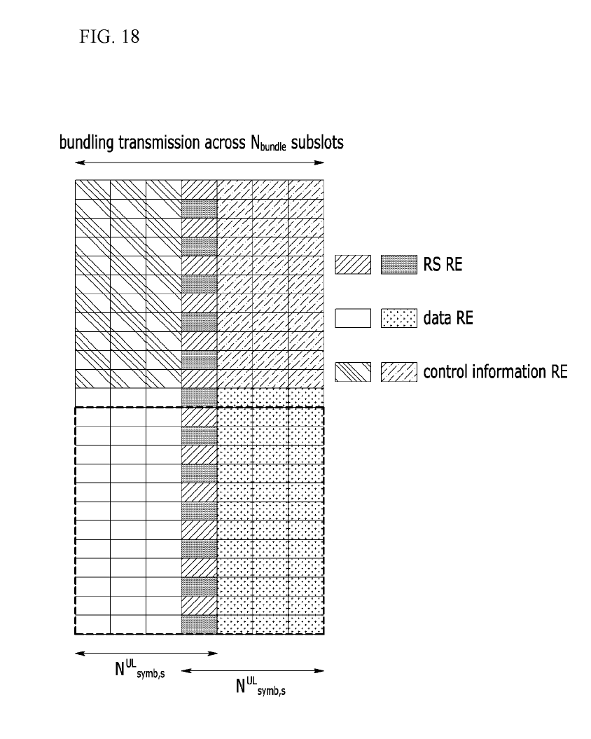

FIGS. 17 and 18 are drawings each illustrating a resource deployment of a case in which uplink control information and data are multiplexed to be transmitted in the short TTI structure illustrated in FIG. 11.

As illustrated in FIG. 17, in the sRB in which the control information and the data are multiplexed and allocated, the control information (RI, CQI) may be preferentially mapped to the RE of the time axis and frequency axis except for the reference signal (RS).

Meanwhile, in the existing LTE system, in the case in which aperiodic control information such as the CSI is multiplexed with the data and transmitted over the PUSCH and the subframe bundling is used, the control information is multiplexed and transmitted in only a corresponding subframe in which the control information should be transmitted. However, since the CSI does not require a very fast transmission latency of 1 ms, when the subslot bundling is used, the same control information may be transmitted across several subslots.

As illustrated in FIG. 18, in the sRB in which the control information and the data are multiplexed and allocated, the control information (RI, CQI) may be preferentially mapped to the RE of the time axis except for the reference signal (RS).

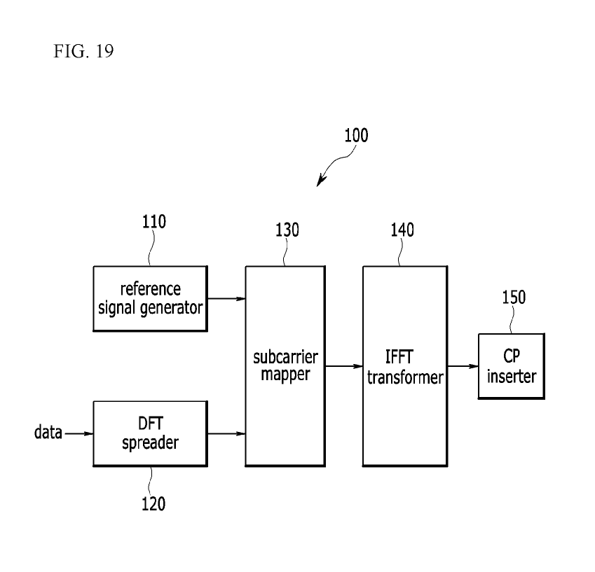

Although FIG. 18 illustrates a case in which the control information (RI, CQI) begins from a first subslot of the sPUSCH performing the bundling transmission, the transmission of the control information (RI, CQI) may be required from an intermediate or final subslot of the sPUSCH performing the bundling transmission. In this case, unlike FIG. 18, the control information (RI, CQI) may be multiplexed and transmitted after the first subslot depending on a transmission timing of the control information (RI, CQI). In FIG. 18, it is illustrated that N_{bundle}=2. FIG. 19 is a drawing illustrating a transmitter according to an exemplary embodiment of the present invention.

Referring to FIG. 19, a transmitter 100 includes a reference signal generator 110, a discrete fourier transform (DFT) spreader 120, a subcarrier mapper 130, an IFFT transformer 140, and a CP inserter 150. The reference signal generator 110 generates a reference signal, for example, a reference signal (RS) for demodulating an uplink signal, and outputs the reference signal (RS) to the subcarrier mapper 130. The reference signal generator 110 may use an orthogonal code having a length of L_{OCC} across L_{OCC} adjacent RS REs on a frequency axis in order to transmit the reference signal (RS). The reference signal generator 110 may spread the reference signal (RS) using the orthogonal code having the length of L_{OCC}.

The DFT spreader 120 spreads input transmission data using DFT and then outputs the spread data to the subcarrier mapper 130. The input transmission data may be a code and modulated symbol sequence.

The subcarrier mapper 130 maps the reference signal (RS) DFT spread data to each of the REs of the sRB. As described in FIG. 3, the subcarriers of the first symbol in one sRB are divided into the Nᵢₙₜₗ interlaces, wherein the first interlace may be used to transmit the reference signal (RS) and from the second interlace to the Nᵢₙₜₗ-th interlace may be used to transmit the data. In order to transmit the data, (Nᵢₙₜₗ−1) interlaces may be used, and the data may be spread by one DFT spreader 120 and may be transmitted in the (Nᵢₙₜₗ−1) interlaces to transmit the data. The subcarrier mapper 130 may multiplex the reference signal (RS) and the DFT spread data, and may map the multiplexed reference signal (RS) and the DFT spread data to each of the REs (subcarrier) in the first symbol of the sRB as described in FIGS. 3 and 4. The subcarrier mapper 130 maps the reference signal (RS) to the subcarrier corresponding to the first interlace of the first symbol of the sRB, and each maps the DFT spread data to subcarriers corresponding to a second interlace to a final interlace of the first symbol. In addition, since only the data is transmitted through a second symbol of the sRB, the subcarrier mapper 130 may appropriately map the data to each of the subcarriers of the second symbol of the sRB.

Further, as described in FIG. 11, the subcarriers of the symbol for transmitting the reference signal (RS) in one sRB are divided into the two interlaces, wherein the first interlace may be used to transmit the reference signal (RS) in the even-numbered subslots and the second interlace may be used to transmit the reference signal (RS) in the odd-numbered subslots. The subcarrier mapper 130 may map the reference signal (RS) to the subcarrier corresponding to the first interlace in the even-numbered subslots, and may map the reference signal (RS) to the subcarrier corresponding to the second interlace in the odd-numbered subslots, as described in FIGS. 11 and 12. Unlike this, the first interlace may also be used to transmit the reference signal (RS) in the odd-numbered subslots, and the second interlace may also be used to transmit the reference signal (RS) in the even-numbered subslots. The subcarrier mapper 130 may appropriately map the DFT spread data to the subcarriers of the remaining transmission symbols except for the symbol for transmitting the reference signal (RS) in the sRB.

Meanwhile, in the case in which the reference signal generator 110 uses the orthogonal code, the subcarrier mapper 130 may map the spread reference signal and the DFT spread data to each of REs of the sRB.

The IFFT transformer 140 performs inverse fast fourier transform (IFFT) for the symbol mapped to each of the REs of one sRB or sRBS and generates an OFDM symbol of a time domain.

The CP inserter 150 inserts CP into the OFDM symbol of the time domain.

The OFDM symbol into which the CP is inserted is transformed into a baseband signal through an RF transport block (not illustrated) and is transmitted via an antenna.

Meanwhile, as illustrated in FIGS. 9, 10, 17, and 18, when the uplink control information (RI, CQI) and the data are multiplexed and transmitted in the sPUSCH, the transmitter 100 may further include a control information generator (not illustrated) generating the uplink control information (RI, CQI). In addition, the subcarrier mapper 130 may map the control information (RI, CQI) to the RE as illustrated in FIGS. 9, 10, 17, and 18. When the subslot bundling is performed, the subcarrier mapper 130 may map the reference signal and the control information (RI, CQI) to the RE of the same position across several subslots, as illustrated in FIGS. 9, 10, 17, and 18.

The functions of the reference signal generator 110, the DFT spreader 120, the subcarrier mapper 130, the IFFT transformer 140, and the CP inserter 150 of the transmitter 100 may be performed by a processor implemented as a central processing unit (CPU), other chipsets, a microprocessor, or the like.

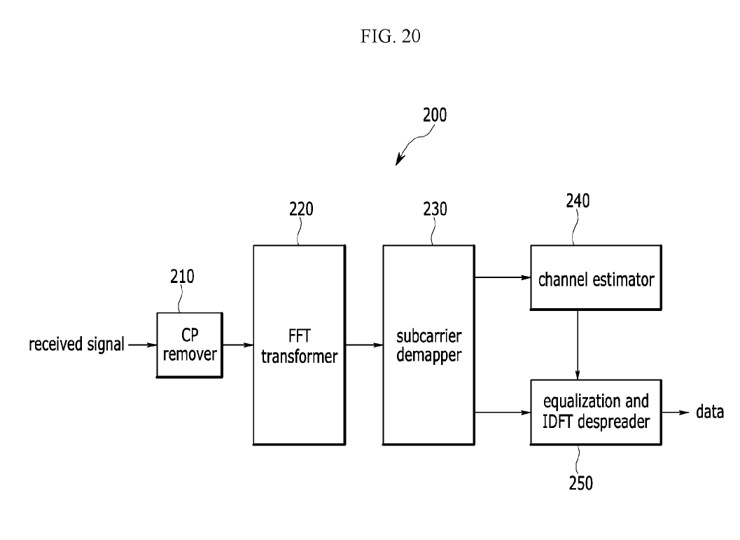

FIG. 20 is a drawing illustrating a receiver according to an exemplary embodiment of the present invention.

Referring to FIG. 20, a receiver 200 includes a CP remover 210, a FFT transformer 220, a subcarrier demapper 230, a channel estimator 240, and an equalization and IDFT despreader 250.

The baseband signal received via the antenna is transformed into the OFDM symbol through an RF reception block (not illustrated).

The CP remover 210 removes the CP from the OFDM symbol, and outputs the OFDM symbol from which the CP is removed to the FFT transformer 220.

The FFT transformer 220 performs the FFT for the OFDM symbol from which the CP is removed to be transformed into a symbol of the frequency domain.

The subcarrier demapper 230 demaps the symbol of the frequency domain and extracts the reference signal (RS) and the data. In the case of the short TTI transmission illustrated in FIG. 3, the subcarrier demapper 230 extracts the reference signal (RS) from the subcarriers corresponding to the first interlace of the first symbol and transmits the extracted reference signal (RS) to the channel estimator 240, and extracts the data from the subcarriers corresponding to the second interlace to the final interlace of the first symbol and transmits the extracted data to the equalization and IDFT despreader 250. The subcarrier demapper 230 extracts the data from the subcarriers of the second symbol and transmits the extracted data to the equalization and IDFT despreader 250. In addition, in the case of the short TTI transmission illustrated in FIG. 11, the subcarrier demapper 230 extracts the reference signal (RS) from the subcarriers corresponding to the first interlace of the symbol for the reference signal transmission in the even-numbered subslots, extracts the reference signal (RS) from the subcarriers corresponding to the second interlace of the symbol for the reference signal transmission in the odd-numbered subslots, and transmits the extracted reference signal (RS) to the channel estimator 240. The subcarrier demapper 230 extracts the data from the subcarriers of the remaining symbols except the symbol for the reference signal transmission in each of the subslots and transmits the extracted data to the equalization and IDFT despreader 250.

The channel estimator 240 estimates a channel using the extracted reference signal (RS).

The equalization and IDFT despreader 250 equalizes the extracted data and performs an IDFT despread for the extracted data using the estimated channel to demodulate the data. The functions of the CP remover 210, the FFT transformer 220, the subcarrier demapper 230, the channel estimator 240, and the equalization and IDFT despreader 250 of the receiver 250 may be performed by a processor implemented as a central processing unit, other chipsets, a microprocessor, or the like.

According to an embodiment of the present invention, a transmission scheme having a short TTI in the uplink of the mobile communication system is provided, thereby making it possible to reduce latency of the service.

The exemplary embodiments of the present invention are not embodied only by an apparatus and/or method described above. Alternatively, the exemplary embodiments may be embodied by a program performing functions, which correspond to the configuration of the exemplary embodiments of the present invention, or a recording medium on which the program is recorded. These implementations can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A transmission method of a transmitter in a mobile communication system, the transmission method comprising:
setting a time length of some transmission symbols to a short transmission time interval (TTI) in a subframe including a plurality of transmission symbols;
multiplexing and transmitting a reference signal and some of transmission data in a first symbol of the transmission symbols within the short TTI; and
transmitting the remainder of the transmission data in the remaining symbols except the first symbol among the transmission symbols within the short TTI.

2. The transmission method of claim 1, wherein:
the multiplexing and transmitting of some of the reference signal and the transmission data includes:
dividing a plurality of subcarriers configuring one resource block into a plurality of interlaces configured of the subcarriers spaced apart from each other by a plurality of subcarrier intervals; and
mapping the reference signal and some of the transmission data to the subcarriers corresponding to different interlaces.

3. The transmission method of claim 2, wherein:
the multiplexing and transmitting of the reference signal and some of the transmission data further includes spreading the reference signal using an orthogonal code before the mapping of the reference signal and some of the transmission data to the subcarriers corresponding to different interlaces.

4. The transmission method of claim 2, wherein:
the multiplexing and transmitting of the reference signal and some of the transmission data further includes setting a short resource block set obtained by grouping a plurality of resource blocks in a frequency domain to a resource allocation basic unit for transmitting the reference signal and the transmission data.

5. The transmission method of claim 1, further comprising:
transmitting the reference signal and the transmission data for a continuous short TTI as much as the number of TTI bundlings according to a TTI bundling instruction.

6. The transmission method of claim 5, wherein:
the transmitting of the reference signal and the transmission data for the continuous short TTI includes multiplexing and transmitting the same control information and the transmission data in the continuous short TTI.

7. The transmission method of claim 6, wherein:
the control information includes channel status information (CSI).

8. The transmission method of claim 6, wherein:
the multiplexing and transmitting of the control information includes preferentially mapping the control information to the remaining subcarriers except a subcarrier to which the reference signal is mapped in the first symbol.

9. The transmission method of claim 6, wherein:
the multiplexing and transmitting of the control information includes preferentially mapping the control information to a resource element on a time axis among the remaining resource elements except a resource element to which the reference signal is mapped in the resource block.

10. A transmission method of a transmitter in a mobile communication system, the transmission method comprising:
setting a time length of one subslot to a short transmission time interval (TTI) in a subframe including a plurality of subslots;
transmitting a reference signal in two subslots using one transmission symbol shared between the two subslots corresponding to an odd-numbered subslot and an even-numbered subslot; and
transmitting transmission data using the remaining transmission symbols except one transmission symbol in the two subslots.

11. The transmission method of claim 10, wherein:
the transmitting of the reference signal includes:
dividing a plurality of subcarriers corresponding to one transmission symbol into two interlaces configured of the subcarriers spaced apart from each other by a plurality of subcarrier intervals within one resource block; and
mapping the reference signal to the subcarriers corresponding to different interlaces in the two subslots.

12. The transmission method of claim 11, wherein:
the transmitting of the reference signal further includes spreading the reference signal using an orthogonal code before the mapping of the reference signal to the subcarriers corresponding to different interlaces.

13. The transmission method of claim 10, further comprising:
setting a short resource block set obtained by grouping a plurality of resource blocks in a frequency domain to a resource allocation basic unit for transmitting the reference signal and the transmission data.

14. The transmission method of claim 10, further comprising:
transmitting the reference signal and the transmission data for a continuous subslot as much as the number of TTI bundlings according to a TTI bundling instruction.

15. The transmission method of claim 14, wherein:
the transmitting of the reference signal and the transmission data for the continuous subslot includes multiplexing and transmitting the same control information and the transmission data in the continuous subslot.

16. The transmission method of claim 15, wherein:
the control information includes channel status information (CSI).

17. The transmission method of claim 10, wherein:
one transmission symbol corresponds to a final symbol of any one of two continuous subslots and corresponds to a first symbol of the other subslot.

18. A transmitter in a mobile communication system, the transmitter comprising:
a reference signal generator generating a reference signal;
a discrete fourier transform (DFT) spreader performing a DFT spread for transmission data; and
a subcarrier mapper mapping and transmitting the reference signal and the DFT spread data to a plurality of resource elements within at least one resource block within a short TTI set to a length of some transmission symbols in a subframe including a plurality of transmission symbols.

19. The transmitter of claim 18, wherein:
the subcarrier mapper divides a plurality of subcarriers configuring each of the resource blocks into a plurality of interlaces configured of the subcarriers spaced apart from each other by a plurality of subcarrier intervals, maps the reference signal and some of the transmission data to the subcarriers corresponding to difference interlaces in a first symbol of the short TTI, and maps the remainder of the transmission data to the plurality of subcarriers in a second symbol of the short TTI.

20. The transmitter of claim 18, wherein:
the subcarrier mapper divides a plurality of subcarriers configuring each of the resource blocks into two interlaces configured of the subcarriers spaced apart from each other by a plurality of subcarrier intervals, maps the reference signal to the subcarriers corresponding to difference interlaces in one transmission symbol shared by two subslots corresponding to an odd-numbered subslot and an even-numbered subslot, and maps the DFT spread data to a plurality of subcarriers of the remaining transmission symbols except one transmission symbol in the two subslots.
